(19) United States
(12) Patent Application Publication
(10) Pub. No.: US 2019/0339928 A1
(43) Pub. Date: Nov. 7, 2019

(54) METHOD AND SYSTEM FOR ASSISTING AIRCRAFT PILOTING

(71) Applicant: THALES, Courbevoie (FR)

(72) Inventors: Stéphanie LAFON, Merignac (FR); Emmanuel Humbert, Merignac (FR); Stéphanie Cardoso, Merignac (FR)

(21) Appl. No.: 16/373,399

(22) Filed: Apr. 2, 2019

(30) Foreign Application Priority Data
May 4, 2018 (FR) 18 00430

(51) Int. Cl. G06F 3/16; G10L 17/22; G06F 3/0484; B64D 43/00

(52) U.S. Cl. CPC G06F 3/165; B64D 43/00; G06F 3/04847; G10L 17/22

(57) ABSTRACT

The invention relates to a method and system for assisting aircraft piloting. The system includes a device for receiving audio messages sent via a radio communication channel, at least one listening device, a data viewing interface and an on-board electronic computing device, including at least one computing processor and at least one electronic memory unit. In a buffer space of the memory unit, an audio signal stream received by the receiving device is continuously recorded, over a recording duration. A synchronization and display control module is configured for obtaining at least one piece of background information relative to the recorded audio signal, segmenting the recorded audio signal into a plurality of temporal segments as a function of the at least one piece of background information, and commanding a display on the viewing interface of an interaction bar representative of the recorded audio signal between a past time moment and a current time moment, identifying the temporal segments, allowing a pilot to select a time moment to begin listening to the recorded audio signal.

### FIELD OF THE INVENTION

The present invention relates to a method and system for assisting aircraft piloting, implemented in a cockpit of a carrier aircraft.

The present invention falls within the field of multimodal man-machine interfaces (MMI) for aircraft cockpits.

### BACKGROUND OF THE INVENTION

Indeed, in a cockpit, the pilot(s) in particular need man-machine interfaces to communicate with outside persons, to exchange operational messages relative to the piloting. It for example involves communications coming from air traffic control (ATC), the navigating personnel, etc.

The known multimodal cockpit man-machine interfaces simultaneously include one or several viewing screens, various control interfaces (touch-sensitive screens, buttons, rotary controls) and audio interfaces (speakers or headsets, for example). Thus for example, the pilots can receive instructions to be applied through various channels, for example by radio.

It was proposed in patent application FR 3,049,753 A1 to use a voice recognition engine to segregate operational audio messages based on keywords recognized in said audio messages. This segregation makes it possible to divide the received audio stream into messages intended for or sent by a given aircraft, and next to associate a priority with these messages and process them based on their priority, which makes it possible to provide services making it possible to assist with piloting, for example: recording messages by priority, increasing the sound level for high-priority messages.

However, the audio environment of a cockpit is very noisy, which decreases the performance of a voice recognition engine.

Furthermore, there are difficulties inherent to voice recognition, due to any pronunciation accents of the different speakers, or the potentially variable manner of pronouncing keywords, which are codes including letters and numbers.

Due to the very presence of noise in the cockpit, it is very common for pilots not to understand the received messages perfectly. In this scenario, it is useful to provide pilots with a tool for re-listening to these messages.

There are devices, similar to the devices proposed to the general public, for recording and replaying an audio recording.

However, the pilot must then choose to relisten (i.e. listen again) from a time moment in the past that he knows only approximately. Additionally, in practice, the on-board recording capabilities are limited by the size of the buffer memories.

The pilot must continue to focus on the current instructions, which makes it difficult to look for and relisten to audio messages received previously.

There is therefore a need to improve piloting assistance by providing pilots with a more ergonomic re-listening tool, making it possible to better target the audio recording part(s) for re-listening.

### SUMMARY OF THE INVENTION

To that end, according to a first aspect, the invention proposes an aircraft piloting assistance system implemented in a cockpit of a carrier aircraft, the system including a device for receiving audio messages sent via a radio communication channel, at least one device for listening to messages, a data viewing interface and an on-board electronic computing device, including at least one computing processor and at least one electronic memory unit. This system includes:

a buffer space of the memory unit in which an audio signal stream received by the receiving device is continuously recorded, over a recording duration,

a synchronization and display control module configured for obtaining at least one piece of background information relative to the recorded audio signal, segmenting the recorded audio signal into a plurality of temporal segments as a function of the at least one piece of background information, and commanding a display on the viewing interface of an interaction bar representative of the recorded audio signal between a past time moment and a current time moment, identifying the temporal segments, allowing a pilot to select a time moment to begin listening to the recorded audio signal.

Advantageously, the identification of temporal segments and their display in the form of an interaction bar allows the pilot to select the re-listening time moment more easily.

The piloting assistance system according to the invention may have one or more of the features below, considered independently or in combination.

The synchronization and display control module is configured for displaying visual indicators making it possible to identify the temporal segments, the visual indicators including a color or a display pattern.

The system further includes a module for determining a beginning time moment and an ending time moment for transmission of an audio message by a pilot of the carrier aircraft, and sending the beginning and ending of transmission moments in time to the synchronization and display control module, and the background information includes the beginning and ending of transmission time moments.

The system further includes a module for determining a radio communication channel frequency change time moment, and the background information includes the radio communication channel frequency change time moment.

The system further includes an audio signal processing module configured for computing at least one characteristic parameter value of at least one recorded audio signal portion and detecting a characteristic parameter value change and a characteristic parameter value change time moment of the audio signal, and the background information includes the characteristic parameter value change moment of the audio signal.

The characteristic parameter of the audio signal is a voice signature making it possible to identify a speaker, the audio signal processing module being configured for comparing at least one characteristic parameter value to previously recorded values, and identifying a speaker associated with the characteristic parameter value change moment of the audio signal.

The synchronization and display control module is configured for displaying each temporal segment with a visual appearance depending on the identified speaker.

The system further includes a module configured for determining, by audio signal processing, a beginning time moment and an ending time moment for transmission of an audio message by an aircraft different from the carrier aircraft, and sending the beginning and ending of transmission moments in time to the synchronization and display control module, and the background information includes the beginning and ending of transmission time moments.

According to a second aspect, the invention proposes an aircraft piloting assistance method implemented by a piloting assistance system in a cockpit of a carrier aircraft, the system including a device for receiving audio streams via a radio communication channel, a device for listening to messages, a data viewing interface and an on-board electronic computing device, including at least one computing processor and at least one electronic memory unit. This method includes the following steps:

continuously recording an audio signal stream received by the receiving device in a buffer space of the memory unit, over a recording duration,

obtaining at least one piece of background information relative to the recorded audio signal,

segmenting the recorded audio signal into a plurality of temporal segments as a function of the at least one piece of background information,

displaying, on the viewing interface, an interaction bar representative of the recorded audio signal between a past time moment and a current time moment, identifying the temporal segments,

obtaining a pilot command to relisten to the recorded audio signal from a re-listening start time moment selected on the interaction bar.

According to one advantageous feature, obtaining at least one piece of background information includes audio signal processing for computing at least one characteristic parameter value of at least one recorded audio signal portion and detecting a characteristic parameter value change and a characteristic parameter value change time moment of the associated audio signal, and an identification of a speaker associated with the characteristic parameter value change moment of the audio signal.

### BRIEF DESCRIPTION OF THE DRAWINGS

Other features and advantages of the invention will emerge from the description thereof provided below, for information and non-limitingly, in reference to the sole FIGURE, which is a schematic illustration of a piloting assistance system according to one embodiment of the invention.

### DETAILED DESCRIPTION OF EMBODIMENTS

The FIGURE schematically shows a piloting assistance system 2 according to one embodiment.

Such a system is for example installed in the cockpit of an aircraft (not shown), which is called carrier aircraft.

The piloting assistance system 2 includes an avionic system 4, including various known modules. Only the modules used in the invention are shown.

The avionic system 4 in particular includes a system for controlling communication channels, including a reception device 6 suitable for receiving audio streams via a radio communication channel. Typically, the audio stream includes audio messages sent by air traffic control (ATC), by an automatic terminal information service (ATIS), or by other aircraft flying in a same air traffic control zone as the carrier aircraft.

The audio messages are provided to one or several listening devices 12. Such a listening device is for example a headset with a speaker and microphone allowing the pilot to listen to the received audio stream and in turn to send audio messages or responses to the received messages.

The avionic system 4 also includes man-machine interfaces, for example a “push to talk” button 8 used by the pilot to send an audio message over the radio communication channel. Indeed, traditionally, the pilot must actuate this button 8 and keep it pressed while sending an audio message. Conversely, when the button 8 is not actuated, the audio communications from the cockpit remain inside this space.

The avionic system 4 also includes a module 10 for determining the active frequency of the radio communication channel used. This module 10 has been shown separately, but can be integrated for example into the control system of the communication channels.

The piloting assistance system 2 is implemented by an on-board computer 14, which is an electronic computing device including an electronic memory unit 16 and one or several processors 18, suitable for executing executable software code instructions.

The piloting assistance method of the invention is implemented by software modules 20, 22, 24, 26 as described hereinafter.

Alternatively, the executable code instructions are recorded on a computer-readable medium, for example an optical disc, a magnetic-optical disc, a ROM memory, a RAM memory, a non-volatile memory (EPROM, EEPROM, FLASH, NVRAM), a magnetic or optical card.

In one variant, the modules 20, 22, 24, 26 are made in the form of a programmable logic component, such as an FPGA (Field Programmable Gate Array), or in the form of a dedicated integrated circuit, such as an ASIC (Application Specific Integrated Circuit).

The modules 20, 22, 24, 26 implement steps of the aircraft piloting assistance method described below.

The audio signal stream received by the receiving device 6 is stored in a buffer space 15 of the memory unit 16, over a given recording duration dT, for example between 3 minutes and 10 minutes, or more, based on the capabilities of the platform. Preferably, the recording duration dT is the duration corresponding to the maximum recording duration in the buffer space 15.

The piloting assistance system 2 implements an audio signal processing module 20, configured for analyzing characteristic parameters of the audio signal and detecting changes in parameter values between analyzed audio signal portions. During the detection of characteristic parameter value change(s), the module 20 also determines an associated change time moment.

In particular, the module 20 is configured for looking for voice signatures, and detecting a voice signature change making it possible to identify a change in speaker. In a known manner, such parameters are for example coefficients obtained from a spectrogram of the audio signal, known in the recognition range of the speaker, for example MFCC (for “Mel-Frequency Cepstrum Coefficients”), RCC (for “Real Cepstrals Coefficients”), LPCC (for “linear predictive cepstral coefficients”) or PLCP (for “perceptual linear predictive cepstral coefficients”). Thus, in one embodiment, a voice signature is characterized by a MFCC value vector.

For example, a distance is computed between characteristic parameters of the audio signal computed at a current time moment T_{c} and the characteristic parameters of the audio signal computed at a previous time moment Tₚ. The computed distance is compared to a predetermined threshold S. For example, the characteristic parameters form a parameter vector, respectively a first parameter vector V_{c} for the first time moment T_{c} and a vector Vₚ for the parameters previously computed and stored. The computed distance is the Euclidean distance between the two vectors V_{c} and Vₚ. Alternatively, other distances may be used.

If the computed distance is above the threshold S, then a change in speaker is detected.

If a change in speaker is detected, in one embodiment, the characteristic parameters representative of voice signatures are recorded in a table of speakers 25, which makes it possible to distinguish the speakers and to compare the determined parameters over a current audio signal portion with previously stored parameters, and thus to identify the occurrence of a message coming from a same speaker. The detection of a change of speaker can be done once the module 20 has acquired enough characteristic parameters on the current voice.

For example, the characteristic parameter vector V_{c} is compared to all of the characteristic parameter vectors recorded in the table of speakers 25, using the distance computation described above. If the distance between V_{c} and one of the recorded characteristic vectors, Vᵢ, is below the threshold S, then the current speaker is considered to be the speaker associated with the characteristic parameter vector Vᵢ.

If the distance between V_{c} and all of the recorded characteristic parameter vectors is above the threshold S, then it is a new speaker, and the characteristic parameter vector is recorded in the table of speakers 25.

In the described embodiment, the piloting assistance system 2 also implements a state change detection module 22 for the “Push to talk” button 8, which makes it possible to determine whether the pilot of the aircraft is in the audio message transmission phase, comprised between a transmission start time moment and a transmission end time moment, respectively corresponding to the time moment where the button 8 is pushed in and the moment where the button 8 is released.

Alternatively, the piloting assistance system 2 does not include a state change module 22 for the “Push to talk” button 8. In this variant, the respective voice signatures of the pilot and copilots of the carrier aircraft are acquired and recorded, for example at the beginning of flight. According to one alternative, the characteristic parameters representing the voice signature of each pilot are computed and stored beforehand, for example on a computer-readable medium such as a memory card, and obtained by the piloting assistance system at the beginning of flight. Thus, the characteristic parameters representing the voice signature of each pilot/copilot are recorded in the table of speakers 25 at the beginning of flight, in order to identify the pilot/copilot without having to detect the state change moment of the button 8.

Lastly, the piloting assistance system 2 further includes a module 24 for determining a radio communication channel frequency change time moment, and an associated radio communication channel frequency change time moment.

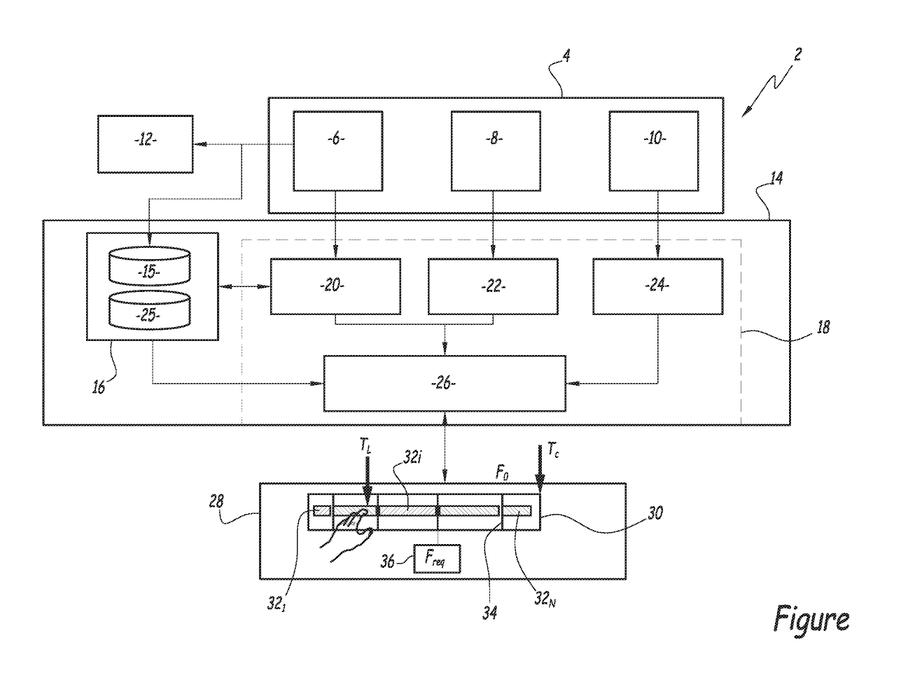

According to one alternative embodiment, the audio signal processing module 20, or another separate module not shown in FIG. 1, is configured for detecting peaks in the processed audio signal portions, a peak corresponding to a characteristic noise of the press or release of a PTT button, and a time moment associated with each peak. These peaks each correspond to a beginning of communication or a stopping of communication by a remote aircraft, and make it possible to determine starting and stopping moments of speech by a remote aircraft pilot different from the carrier aircraft.

Each of the modules 20, 22, 24 sends information to the synchronization and display control module 26. This information is called background information.

In one embodiment, the background information includes:

the time moment of the characteristic parameter value change of the audio signal, the characteristic parameter value and, if applicable, the associated speaker;

the time moment of the radio communication channel frequency change;

optionally, beginning and ending of transmission time moments of an audio message by a pilot of the carrier aircraft, as well as the beginning and ending of transmission time moments of an audio message by a remote aircraft, detected by the detection of peaks in the audio signal.

The module 26 uses the background information to segment the recorded audio signal into temporal segments, each temporal segment corresponding to a change for at least one of the received pieces of background information.

Each segment corresponds to a speaking time used by a speaker.

For example, the detection of pressing of the button 8 makes it possible to determine a segment transmitted by the pilot of the carrier aircraft. Likewise, the detection of peaks in the audio signal makes it possible to determine the beginning and ending of transmission time moments of an audio message by a remote aircraft pilot.

Furthermore, the detection of a frequency change makes it possible to determine the moment where the carrier aircraft changed air traffic control zones, in which case potentially all of the speakers change (except the pilot and copilot of the carrier). Nevertheless, it is possible for surrounding aircraft to be found in the same air traffic control zone as the carrier aircraft again.

Preferably, in the table 25, the characteristic parameters of the recorded voice signatures are associated with an aircraft identifier, for example using the recognition of an aircraft call-sign stated by a speaker (aircraft pilot) using aeronautic phraseology. The characteristic parameters representative of voice signatures coming from aircraft located in the same air traffic control zone as the carrier aircraft, after having validated their presence in this control zone.

For example, the characteristic parameters representative of voice signatures coming from aircraft moving in the same direction as the carrier aircraft are kept, and the parameters associated with the aircraft moving in the opposite direction are erased.

The module 26 is configured for monitoring the display, on a viewing interface 28, of an interaction bar 30 representative of a recorded audio signal between a past time moment and a current time moment, and displaying the previously obtained temporal segments 32₁, 32ᵢ, 32_{N}.

Preferably, the viewing interface is of the touch-insensitive slab type and serves as control interface for the operator (pilot or copilot of the carrier aircraft).

The display includes visual indicators, for example vertical separating lines, allowing easy identification of the segments.

It should be noted that in the illustrated example, the temporal segments 32₁, 32ᵢ, 32_{N} follow one another. Nevertheless, if several audio messages arrive at the same time, the corresponding segments will be shown in a staged manner relative to the temporal axis.

Preferably, the audio signal temporal segments emitted by the carrier aircraft are shown differently (for example by the pattern and/or the color) relative to the segments corresponding to audio signals received from the outside.

In one embodiment, the successive temporal segments associated with a same speaker are merged, if the break in speech between these segments is shorter than a given duration. In this case, two successive temporal segments have a different visual appearance, pattern and/or display color.

If a voice signature is recognized, preferably a same appearance (pattern and/or color) is given to each audio segment associated with a same speaker, so as for example to allow the pilot to identify the origin of the audio segments more easily, in particular segments coming from an air traffic controller.

In one embodiment, a default color (e.g., white) is associated with the segments as long as the system has not associated a speaker identifier with these segments. When the speaker is identified, a different visual appearance, color or pattern, associated with the identified speaker is assigned to the corresponding segments when refreshing the display. For example, in one embodiment, each speaker recorded in the table of speakers 25 is associated with a visual appearance indicator, for example a color. This visual appearance indicator associated with the speaker is stored, for example in the table of speakers 25. Thus, when a speaker is associated with a segment, the visual appearance indicator, for example the display color of the associated segment, is obtained directly from the table of speakers 25.

Optionally, visual indicators 34, for example vertical bars, are displayed to show changes in background information. In one embodiment, background information 36 is also displayed, for example an active frequency value when a change in frequency has been detected.

The pilot can then select, using a pointing device, preferably through a tactile operation, a time moment T_{L} for the beginning of re-listening based on the displayed segments.

The module 26 is then configured for sending a replay command for the recorded audio signal from the time moment T_{L}, and the audio signal is sent to the listening device 12.

Furthermore, sliding the finger over the segments makes it possible to advance or rewind the reading, which enhances the ergonomics of the system.

Of course, the display is updated in real time, relative to the audio signal recorded in the buffer memory.

It should be noted that even if the division of the audio signal into temporal segments is slightly offset relative to the change of speaker, this division greatly assists the pilot in selecting the segment to be replayed. For example, the pilot can command a replay from a temporal moment that is slightly in advance relative to the targeted segment. Owing to the visual indicators (patterns/colors) and the division into temporal segments, the pilot can very easily identify the part of the recorded audio stream that he wishes to hear again.

1. An aircraft piloting assistance system implemented in a cockpit of a carrier aircraft, the system including a device for receiving audio messages sent via a radio communication channel, at least one device for listening to messages, a data viewing interface and an on-board electronic computing device, including at least one computing processor and at least one electronic memory unit, comprising :
a buffer space of the memory unit in which an audio signal stream received by the receiving device is continuously recorded, over a recording duration,
a synchronization and display control module configured for obtaining at least one piece of background information relative to the recorded audio signal,
segmenting the recorded audio signal into a plurality of temporal segments as a function of the at least one piece of background information,
and commanding a display, on the viewing interface, of an interaction bar representative of the recorded audio signal between a past time moment and a current time moment, identifying the temporal segments, allowing a pilot to select a time moment for the beginning of re-listening to the recorded audio signal.

2. The system according to claim 1, wherein the synchronization and display control module is configured for displaying visual indicators making it possible to identify the temporal segments, the visual indicators including a color or a display pattern.

3. The system according to claim 1, further including a module for determining a beginning time moment and an ending time moment for transmission of an audio message by a pilot of the carrier aircraft, and sending the beginning and ending of transmission moments in time to the synchronization and display control module, and wherein the background information includes the beginning and ending of transmission time moments.

4. The system according to claim 1, further including a module for determining a radio communication channel frequency change time moment, and wherein the background information includes the radio communication channel frequency change time moment.

5. The system according to claim 1, further including
an audio signal processing module configured for computing at least one characteristic parameter value of at least one recorded audio signal portion and detecting a characteristic parameter value change and a characteristic parameter value change time moment of the audio signal, and wherein the background information includes the characteristic parameter value change moment of the audio signal.

6. The system according to claim 5, wherein the characteristic parameter of the audio signal is a voice signature making it possible to identify a speaker, the audio signal processing module being configured for comparing at least one characteristic parameter value to previously recorded values, and identifying a speaker associated with the characteristic parameter value change moment of the audio signal.

7. The system according to claim 6, wherein the synchronization and display control module is configured for displaying each temporal segment with a visual appearance depending on the identified speaker.

8. The system according to claim 1, further including a module configured for determining, by audio signal processing, a beginning time moment and an ending time moment for transmission of an audio message by an aircraft different from the carrier aircraft, and sending the beginning and ending of transmission moments in time to the synchronization and display control module, and wherein the background information includes the beginning and ending of transmission time moments.

9. An aircraft piloting assistance method implemented by a piloting assistance system in a cockpit of a carrier aircraft, the system including a device for receiving audio streams via a radio communication channel, a device for listening to messages, a data viewing interface and an on-board electronic computing device, including at least one computing processor and at least one electronic memory unit, comprising:
continuously recording an audio signal stream received by the receiving device in a buffer space of the memory unit, over a recording duration,
obtaining at least one piece of background information relative to the recorded audio signal,
segmenting the recorded audio signal into a plurality of temporal segments as a function of the at least one piece of background information,
displaying, on the viewing interface, an interaction bar representative of the recorded audio signal between a past time moment and a current time moment, identifying the temporal segments,
obtaining a pilot command to relisten to the recorded audio signal from a re-listening start time moment selected on the interaction bar.

10. The method according to claim 9, wherein obtaining at least one piece of background information includes audio signal processing for computing at least one characteristic parameter value of at least one recorded audio signal portion and detecting a characteristic parameter value change and a characteristic parameter value change time moment of the associated audio signal,
and an identification of a speaker associated with the characteristic parameter value change moment of the audio signal.
